(19) United States
(12) Patent Application Publication
(10) Pub. No.: US 2019/0120525 A1
(43) Pub. Date: Apr. 25, 2019

(54) SOLAR PANEL ASSEMBLY

(71) Applicant: Gaia Renewable Energy Limited, Llangenech (GB)

(72) Inventor: Jamie Morris, Blaenau (GB)

(21) Appl. No.: 16/094,697

(22) PCT Filed: Apr. 13, 2017
(86) PCT No.: PCT/GB2017/051038

§ 371 Date: Oct. 18, 2018

(30) Foreign Application Priority Data
Apr. 18, 2016 (GB) 1606726.6

(51) Int. Cl. F24S 20/70; F24S 20/55; F24S 20/80; F24S 25/11; H02S 20/30

(52) U.S. Cl. CPC F24S 20/70; F24S 20/55; H02S 20/30; F24S 25/11; F24S 20/80

(57) ABSTRACT

A solar panel assembly is provided that comprises at least one solar panel (2) and a support structure (12) for supporting the at least one solar panel (2). The support structure (3) comprises a collapsible enclosure including a base (16) and plurality of walls (18, 20, 22) defining a sealed tillable chamber. The at least one solar panel (2) is mounted to one of the walls in use. At least part of the shell is formed of a flexible material arranged such that the enclosure is reconfigurable between a collapsed configuration and an expanded deployed configuration when the enclosure is filled. In the expanded deployed configuration the solar panel (2) is supported and arranged such that it is upwardly angled to receive solar energy.

The present invention relates to a solar panel assembly, and in particular a solar panel assembly for remote off-grid applications.

Off grid power supply requires a means of independent in-situ power generation. Typical off grid power solutions, for sites with a power demand but no electrical infrastructure, comprise a diesel or petrol fuelled electrical generator. Such units require frequent re-fuelling, and can be difficult to transport to remote locations, particularly where a high power demand requires larger generator units. Diesel generators are also becoming less desirable as the demand for renewable energy sources increases. Portable renewable energy generators such as solar panels or wind turbines are therefore becoming increasing popular.

Photovoltaic (PV) solar panels provide an effective means of off-grid power supply. PV panels may be installed in a modular arrangement in which the number of panels is varied according to the power demand. For effective and efficient power generation a PV panel array must be arranged at a suitable angle and orientation to optimise the incident solar radiation. This requires the PV panels being titled to a pre-selected angle dependant on the location of the panel. Typically, temporary solar panel installations utilise a metal frame having an angled base support structure on which the PV panels are mounted. To ensure the PV panels are safe in use, and remain in the optimum position, the support frames are anchored. This generally involves the support frames being secured by anchoring the frame to the ground with concrete.

Therefore such frames are not generally capable of being deployed in areas where the ground conditions are unsuitable, for example, in wet or marshy ground. Furthermore, the requirement to transport heavy and bulky metal frames to a remote location, and to then construct the frame and create a stable anchor structure, is not desirable. In addition to the cost of the frames themselves, installation costs can also be significant for semi-permanent metal frame structures of this type. Furthermore, following use the support frames must be dismantled which can again be costly and time consuming, as well as leading to significant material waste and damage to the environment (e.g. pile driven holes, poured concrete) that must be remedied.

It is therefore desirable to provide an improved remotely deployable solar panel assembly and a support for a solar panel assembly which addresses the above described problems and/or which offers improvements generally.

According to the present invention there is provided a solar panel assembly as described in the accompanying claims.

In an embodiment of the invention there is provided a solar panel assembly comprising at least one solar panel and a support structure for the at least one solar panel. The support structure comprises a shell or enclosure including a base and plurality of walls defining a sealed fillable chamber. The at least one solar panel is mounted to one of the walls in use. At least part of the shell is formed of a flexible material arranged such that the enclosure is reconfigurable between a collapsed configuration and an expanded deployed configuration when the enclosure is filled. In the expanded deployed configuration the solar panel is support and arranged such that it is upwardly angled to receive solar energy. This arrangement advantageously enables the support to be transported in a fully formed but compact configuration. Assembly at the point of use requires only the unfurling and filling of the support and subsequent connection of the panels to the deployed support. No complex assembly of the support is required, and the use of a fillable support allows a low weight and cost effective support to be provided.

The solar panels may be photovoltaic panels, solar thermal panels or any other panels configured to harvest solar energy. The term ‘fillable’ with regard to the enclosure includes the filling of the enclosure with any suitable flowable material which may be gas, liquid or solid, and includes an inflatable enclosure. In a further advantage, the ability to inflate the support structure provides the support structure with buoyancy which enables it to be used on water or heavily saturated ground or marshland.

The solar panels are preferably mountable to an outer surface of one of the walls of the support structure.

The structure includes a closure member that closes and seals the enclosure when inflated to maintain the enclosure in an inflated state. The closure member may be a valve or a sealing cap provided in addition or alternatively to the valve.

The solar panels are preferably detachably mountable to the support structure, with the solar panels and the support panel including co-operating connection elements. The ability to detach the solar panels allows them to be stacked for transport separately to the support structure. It also enables the support structure to be more easily filled without the panels attached. The support panel may include mechanical fixings secured to the surface thereof, for example with a vulcanised bond. The mechanical fixings cooperate with corresponding mechanical fixings on the solar panels to enable the solar panels to be mounted to the support surface. The mechanical fixings may be releasable fixings arranged to allow the solar panels to be readily detachable, or may be configured to provide a more permanent and secure connection.

Preferably the shell is formed from a flexible, non-permeable fabric. This enables the enclosure to be inflated with gas and/or liquid and to maintain its inflated state once closed and sealed. It also prevents water ingress into the enclosure.

Preferably each of the walls of the shell is formed of a flexible material. While in one embodiment some of the panels may be rigid, with the flexible panel forming a collapsible bellows type arrangement, it is preferable that all the walls of the shell are flexible as this allows a more compact storage configuration and minimises weight and cost.

The wall to which the solar panel is mounted defines a support panel. The support panel and the base are preferably configured such that in the expanded deployed condition the support panel is arranged at an acute angle to the base. This ensures that the solar panel or panels mounted on the support panels are upwardly facing for solar collection.

The support panel is preferably angled upwardly and rearwardly from a front edge of the base and a rear wall extends between the upper edge of the support panel and the rear edge of the base such that the support has a substantially triangular wedge shaped form in the deployed condition. This wedge shape of the support provides a stable, low profile form that also minimises material usage. Furthermore, in arrangements of the prior art the solar panels are held in an open frame with the rear of the frame exposed. This creates a large surface area beneath the panel that is prone to wind forces. The provision of a rear panel that closes off and slopes away from the rear surface of the solar panel prevents this ‘sail effect’ and allows a smooth air flow over the solar panel assembly.

The height of the rear wall is preferably adjustable to vary the angle of the support panel relative to the base. This enables the angle of the panels to be varied in situ depending on the required incident angle of the panels. At least one adjustment element is provided that is arranged to cause a change in the height of the rear panel. Preferably the adjustment element is arranged such that a variation in the length of the adjustment element causes a corresponding change in the height of the rear panel. Preferably the adjustments element is a strap provided on and secured to the rear panel that is variable in length, the strap being connected to the rear panel such that a variation in the length of the strap causes a corresponding change in the height of the rear panel. In addition or alternatively the angle of the support panel may be varied by adjusting the level of inflation of the enclosure.

The sealed enclosure preferably includes an inlet arranged to allow a flowable matter to be provided into the enclosure to fill the enclosure and cause it to expand to the deployed configuration. The inlet may be any suitable sealable aperture. In one embodiment the inlet may comprises a valve for inflation of the enclosure.

The support structure may be deployed by inflating the enclosure with a combination of water and air. The enclosure may be partially filled with water which flows to the base of the enclosure. The remaining volume of the enclosure may be inflated using air. The enclosure may include a liquid inlet and a separate air inlet located above the liquid inlet, or both the water and air may be supplied through a common inlet. The water and air may fill a common volume, or the enclosure may include separate chambers for the water and air.

Preferably the internal void of the enclosure of the support structure includes an upper chamber and a lower chamber. The lower chamber defines a ballast chamber and includes an inlet to allow the ballast chamber to be filled with a weighted flowable material, for example water or sand, which may be separate to the inlet of the upper chamber. The ballast chamber enables a weighted material to be provided into the base of the support of anchor and stabiles the support. The use of a fillable ballast chamber enables the support to advantageously be manufactured and transported without a weighted ballast, which is added at the point of use and then disposed of when it is required to move the support.

The ballast chamber may be separated from the upper chamber by an internal partition wall.

The base of the shell is preferably also formed of a flexible material. This allows the base to confirm to the ground upon which it is supported which maximises the flexibility of the support enabling it to be used in a broad range of environments.

The enclosure of the support may include one or more tension elements arranged to limit expansion of the enclosure. The tension or brace elements are preferably non-elastic flexible members that are not extendable under tension when extended to a fully unfurled state. The tension elements may comprises a series of internal flexible brace panels or tension straps provided internally along the length of the support. The elements extend between and link two or more panels and ensure the enclosure holds and does not inflated further than a predetermined fixed shape when it is filled by holding the panels in a fixed spaced relationship. The brace elements may extend across the internal void of the enclosure. Preferably the brace elements are not configured to fully partition the enclosure into separate chambers along its length. As such the enclosure can still be inflated from one single inlet location.

In another aspect of the invention there is provided a method of installing a solar panel assembly. The method comprises providing at least one solar panel and a support structure for the solar panel. The support structure comprises a shell including a base and plurality of walls defining a sealed fillable enclosure. At least part of the shell is formed of a flexible material. The support structure is transported to the point of use in a collapsed configuration. At the point of use the enclosure is filled to reconfigure the support structure from the collapsed configuration to an expanded deployed configuration and at least one solar panel is secured to the support structure.

The step of filling the enclosure may comprise inflating the enclosure with a gas such as air and closing and sealing the enclosure when inflated.

The enclosure may include a ballast chamber and the method may further include filling the ballast chamber with a weighted material which is preferably flowable.

The present invention will now be described by way of example only with reference to the following illustrative figures in which:

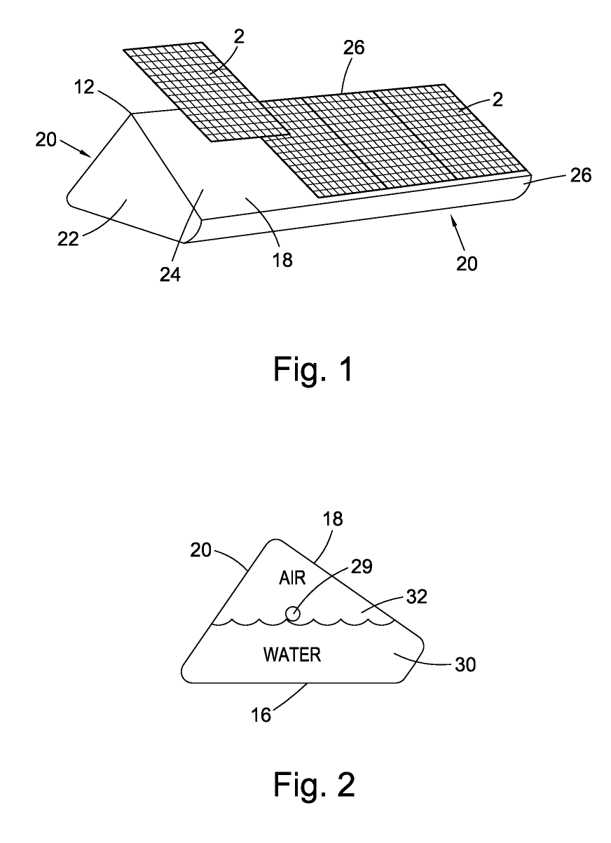

FIG. 1 shows a solar panel assembly according to an embodiment of the invention;

FIG. 2 shows an illustrative cross section of a solar panel support according to an embodiment of the invention;

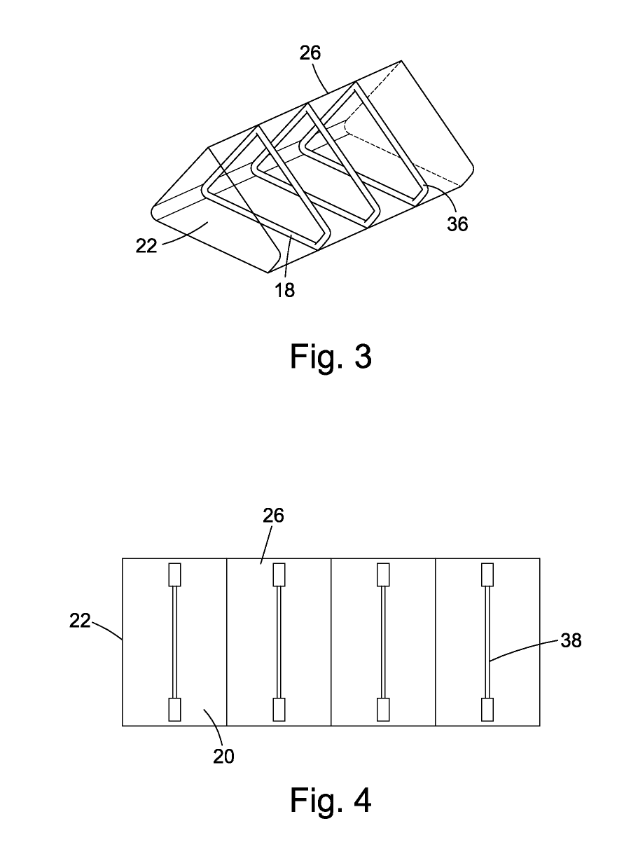

FIG. 3 shows a further view of a solar panel assembly according to an embodiment of the invention; and

FIG. 4 is a rear view of a solar panel assembly according to an embodiment of the invention.

As shown in FIG. 1, a solar panel assembly 11 includes solar panels 2 secured on a support 12. The rectangular solar panels 2 are arranged on the support 12 in a side by side array. The support structure 12 comprises a flexible shell 14 formed from a flexible, non-permeable material. The shell 14 may be formed from 1050 gms polyester coated PVC, although a suitable flexible, non-permeable material may be used. The material is also preferably fire retardant. The shell 14 comprises a base panel 16, a front panel 18, a rear panel 20 and end panels 22. The panels of the shell 14 are connected in a sealed manner and form a closed, sealed, hollow chamber or bladder. The front panel 18 includes a main upper panel section 24 that is angled upwardly and rearwardly from the base 16. Here the terms ‘upper’, ‘lower’, ‘front’ and ‘rear’ are relative and are used in the context of the orientation of the assembly in its deployed configuration in use, with the front of the assembly being defined by the direction in which the solar panels face when the assembly is deployed in use. A lower section 26 of the front panel defines a shallow lower wall that extends upwardly or is angled slightly forwardly from the base.

The main upper section 24 of the front panel 18 is arranged at an acute angle to the base 16 oriented in the rearward direction. The main upper section 24 of the front panel 18 defines a support panel for supporting the solar panels 2. The angle of support panel 24 ensures the solar panels 2 face upwardly in use. The angle is preferably around 35° to the horizontal plane defined by the base 16, although the angle is adjustable as described below. The support panel 24 is provided with mechanical fixings (not shown) that are secured to the support panel 24 with a vulcanised bond or other suitable securing means, the mechanical fixings providing connection points for securement to corresponding fixing connectors on the solar panels 2. Alternatively a Velcro® material may be provided the support panel 24 and the lower surface of the solar panels 2 may be provided with corresponding Velcro® panels to enable the solar panels 2 to secure to the support surface 24 in a quick and easy manner. The support surface may be covered in a single expanse of Velcro® or by a series of discrete panels corresponding to the footprint of each solar panel 2. The base wall defined by the lower section 26 of the front panel 18 ensures that the lower edges of the solar panels 2 are supported away from the ground.

The rear panel 20 is angled upwardly from the rear edge of the base panel 16 in the forward direction at an acute angle. The upper edge of the rear panel 20 meets the upper edge of the front panel 18 at the upper edge 26 at an apex forming the upper ridge 26. The front panel 18, rear panel 20 and base 16 are connected to form a substantially triangular wedge shaped cross sectional channel, closed at the ends by the end panels 22 to form a sealed enclosure. An opening 29 provides an inlet/outlet to the sealed enclosure that allows the enclosure to be filled with flowable matter.

The flexible material from which the shell 14 is formed allows it to collapse when emptied to a substantially flat configuration in which it may be folded, rolled, or otherwise stowed for transit or storage. In one embodiment the inlet may comprise a valve, which may be a one way valve, to which a source of pressurised air may be connected to fill the enclosure with air and inflate it to an expanded, deployed condition as shown in FIG. 1. The non-permeable material is air tight which allows the enclosure to remain inflated when the valve is closed. In other embodiments the opening may permit the enclosure 14 to be filled with other flowable material in addition to or instead of air. In one embodiment the enclosure may be fillable with foam beads such as polystyrene beads or other light weight flowable materials.

As shown in the FIG. 2, the enclosure may be filled with both air and water. The water is stored in the base 30 of the enclosure, which defines a ballast section 30, and the air is housed above the water in the upper section 32. Preferably the ballast section 30 is a discrete chamber that is partitioned from the chamber defined by the upper section 32 and may include a separate inlet for filling the ballast chamber 30 with water. The ballast section 30 is preferably a substantially rectangular, cuboid chamber. The upper chamber 32 is a substantially triangular, wedge shaped chamber.

In one embodiment, as shown in FIG. 3, a series of internal brace panels or brace elements 36 are provided internally along the length of the support 12. The brace panels 36 extend between and link two or more panels and help the enclosure 14 hold its shape as it is filled. The brace panels 36 extend across the internal void of the enclosure, but are not configured to partition the enclosure into separate chambers along its length. As such the enclosure can still be inflated from one single inlet location. Straps such as tension straps or any other suitable means may be used in addition or alternatively.

As shown in FIG. 4, adjustment straps 38 are provided on the rear panel 20. The adjustment straps 38 are connected lengthwise along the height of the rear panel 20. The adjustment straps are connected to the rear panel 20 at two locations at the upper and lower ends of the rear panel 20, and are adjustable in length between the connection locations. As such, adjustment in the length of the adjustment straps 38 pulls the connection locations together or extends them apart, thereby varying the height of the rear panel 20. In the deployed configuration, adjustment of the height of the rear panel 20 raises and lowers the ridge 26 and causes the front panel 18 to pivot about its front edge thereby varying the angle of the support panel 24 relative to the base 16. The straps 38 may include friction buckle adjusters or any other suitable means of adjusting the strap length.

In use, the solar panel assembly 11 is transported to a required location with the solar panels 2 disconnected from the support 12 and stacked or otherwise stowed separately. The support 12 is transported in the collapsed state, in which it is substantially flat and may be folded. At the point of use the required direction of the solar panels is first assessed, together with the panel angle to optimise the incident solar radiation on the panels. The support 12 is moved to the required location for use and arranged at the selected orientation. The upper chamber 32 is inflated with air or otherwise filled to the expanded, deployed configuration. The ballast section 30 is filled with water or another flowable weighted material such as sand. The flexible nature of the base panel 16 means that it is able to conform to the shape of the ground on which it is located. An extremely secure and stable base is therefore provided that is adaptable to almost any terrain.

In the deployed form the support 12 has a substantially triangular wedge shaped form. With the support panel 24 facing in the selected direction, the angle of the support panel 24 is checked and adjusted if necessary to achieve the optimum panel angle. The angle of the support panel 24 may be varied by adjusting the length of the adjustment straps 38 and/or by variation the level of inflation or degree of filling of the enclosure; the greater the inflation, the steeper the angle of the support panel 24.

Once the support panel 24 has been set at the required angle and orientation the solar panels 2 are secured to the support panel 24 by the mechanical fixings. The solar panels 2 are then electrically connected to each other to form a panel array. The array is then connected to an electrical load and/or a means or electrical storage such as a battery array.

In another embodiment, the at least part of the flexible shell 14 may be configured to harden in the deployed configuration to form a permanent or semi-permanent rigid structure. The flexible material from which the enclosure is formed may include a material which hardens over time in contact with air. Alternatively the material may be impregnated or include a coating which sets and hardens on contact with water. The material may for example be a fabric that is impregnated or coated with a material such as concrete. Once deployed the shell 14 may be sprayed with water causing the concrete to saturate. The saturated concrete then dries, sets and hardens to form a rigid structure. This allows a more permanent structure to be created that can be left and will not deflate over time. Alternatively, or in addition, the enclosure may be filled with a solidifying filling material such as an expandable foam or beads which bond and solidify to a unitary solid form.

1. A solar panel assembly comprising:
at least one solar panel; and
a support structure for the at least one solar panel, the support structure comprising a shell including a base and plurality of walls defining a sealed tillable enclosure, the at least one solar panel being mountable to one of the walls;
wherein at least part of the shell is formed of a flexible material arranged such that the enclosure is reconfigurable between a collapsed configuration and an expanded deployed configuration when the enclosure is filled.

2. A solar panel assembly according to claim 1, wherein each of the walls of the shell is formed of a flexible material.

3. A solar panel assembly according to claim 1, wherein the wall to which the solar panel is mounted defines a support panel, and the support panel and the base are configured such that in the expanded deployed condition the support panel is arranged at an acute angle to the base.

4. A solar panel assembly according to claim 3, wherein the support panel is angled upwardly and rearwardly from a front edge of the base and a rear wall extends between the upper edge of the support panel and the rear edge of the base such that the support has a substantially triangular wedge shaped form in the deployed condition.

5. A solar panel assembly according to claim 4, wherein the height of the rear wall is adjustable to vary the angle of the support panel relative to the base.

6. A solar panel assembly according to claim 5, wherein at least one adjustment strap is provided on the rear panel that is variable in length, the strap being connected to the rear panel such that a variation in the length of the strap causes a corresponding change in the height of the rear panel.

7. A solar panel assembly according to claim 1, wherein the sealed enclosure includes an inlet arranged to allow a flowable matter to be provided into the enclosure to fill the enclosure and cause it to expand to the deployed configuration.

8. A solar panel assembly according to claim 7, wherein the inlet comprises a valve.

9. A solar panel assembly according to claim 1, wherein the flexible material of the enclosure is formed from a non-permeable material.

10. A solar panel assembly according to claim 1, wherein the enclosure of the support structure includes an upper chamber and a lower chamber, the lower chamber defining a ballast chamber and including an inlet to allow the ballast chamber to be filled with a weighted flowable material.

11. A solar panel assembly according to claim 1, wherein the base of the shell is formed of a flexible material.

12. A solar panel assembly according to claim 1, wherein at least one of the solar panels is a photovoltaic solar panel.

13. A solar panel assembly according to claim 1, wherein at least one of the solar panels is a solar thermal panel

14. A solar panel assembly comprising a shell including a base and plurality of walls defining a sealed fillable enclosure, at least one of the walls defining a support panel including a connector for securing a solar panel to the support panel, wherein at least part of the shell is formed of a flexible material arranged such that the enclosure is reconfigurable between a collapsed configuration and an expanded deployed configuration.

15. A solar panel assembly according to claim 14, wherein each of the walls of the shell is formed of a flexible material.

16. A support for a solar panel according to claim 14, wherein the support panel and the base are configured such that in the expanded deployed condition the support panel is arranged at an acute angle to the base.

17. A support for a solar panel according to claim 16, wherein the support panel is angled upwardly and rearwardly from a front edge of the base and a rear wall extends between the upper edge of the support panel and the rear edge of the base such that the support has a substantially triangular wedge shaped form in the deployed condition.

18. A support for a solar panel according to claim 15, wherein the height of the rear wall is adjustable to vary the angle of the support panel relative to the base.

19. A support for a solar panel according to claim 14, wherein the sealed enclosure includes an inlet arranged to allow a flowable matter to be provided into the enclosure to fill the enclosure and cause it to expand to the deployed configuration.

20. A support for a solar panel according to claim 19, wherein the inlet comprises a valve.

21. A support for a solar panel according to claim 14, wherein the enclosure of the support structure includes an upper chamber and a lower chamber, the lower chamber defining a ballast chamber and including an inlet to allow the ballast chamber to be filled with a weighted flowable material.

22. A support for a solar panel according to claim 14, wherein the base of the shell is formed of a flexible material.
